(19) United States
(12) Patent Application Publication
(10) Pub. No.: US 2018/0322472 A1
(43) Pub. Date: Nov. 8, 2018

(54) SYSTEM FOR MANAGING FLEET VEHICLE MAINTENANCE AND REPAIR

(71) Applicant: AVIS BUDGET CAR RENTAL, LLC, Parsippany, NJ (US)

(72) Inventor: DAVID RUSSELL, BERKS (GB)

(21) Appl. No.: 15/934,887

(22) Filed: Mar. 23, 2018

Related U.S. Application Data
(60) Provisional application No. 62/475,527, filed on Mar. 23, 2017.
(60) Provisional application No. 62/475,449, filed on Mar. 23, 2017.

(51) Int. Cl. G06Q 10/00; G07C 5/00; G07C 5/08; G06Q 30/02; G06Q 30/06

(52) U.S. Cl. CPC G06Q 10/20; G07C 5/008; G06Q 30/0645; G07C 5/006; G06Q 30/0283; G07C 5/085

(57) ABSTRACT

An improved system and related methods for management and control of fleet vehicle condition, maintenance, damage assessment and recovery, and repair. A return application is used to process the return of a fleet vehicle, including the detecting and recording (such as by digital images or videos) of damage to the vehicle (internal or external), and the need for maintenance of one or more vehicle components or systems. A maintenance application allows the capture of maintenance and/or damage problems or issues that arise outside of vehicle rental or use, and thus would not be captured by the vehicle return process. The system automatically creates an repair or maintenance order based on the vehicle condition information (including information gathered upon vehicle return, if applicable). The system may automatically direct a repair to the most cost effective supplier based on the total cost and other parameters of the repair, including, but not limited to, repair time, logistics, expenses, and similar factors.

This application claims benefit of and priority to U.S. Provisional Application No. 62/475,449, filed Mar. 23, 2017, and U.S. Provisional Application No. 62/475,527, filed Mar. 23, 2017, and is entitled to those filing dates for priority. The specification, figures, appendices and complete disclosures of U.S. Provisional Applications Nos. 62/475,449 and 62/475,527 are incorporated herein in their entireties by specific reference for all purposes.

### FIELD OF INVENTION

This invention relates to an improved system and related methods for management and control of fleet vehicle condition, maintenance, damage assessment and recovery, and repair.

### BACKGROUND OF THE INVENTION

A fleet asset management system, such as a vehicle reservation and return system, or a vehicle maintenance and repair, typically stores information related to the fleet assets themselves, along with the demands on those assets, within a database. Such information may include asset availability as a function of time, periods of time for which particular assets are to be used (i.e., reserved), periods of time for which particular assets are free, and when assets need to be taken off service for maintenance or repair. Vehicle use operations include but not limited to, providing a fleet of vehicles for rental or use (included shared use), enrolling or registering users, scheduling or reserving vehicles for approved or authorized users, monitoring the vehicle while being used, predicting vehicle arrival or return times and locations (including the identification of likely late returns), and processing vehicle returns (including damage and maintenance issues). Types of users vary depending on the nature of the fleet. For example, users may be employees of the owner of a corporate or municipal utility fleet, authorized drivers of a bus fleet, drivers of taxi-cabs, renters or customers of a car rental agency, or members of a car sharing service. Accordingly, the types of vehicle use operation systems used above will vary as well.

### SUMMARY OF THE INVENTION

In various exemplary embodiments, the present invention comprises an improved system and related methods for management and control of fleet vehicle condition, maintenance, damage assessment and recovery, and repair. The fleet can be a rental vehicle fleet, shared vehicle, a corporate vehicle fleet, or other plurality of vehicles, including, but not limited to, automobiles, trucks, vans, buses, motorcycles, bicycles, and the like. The system provides a unique, single integrated platform, and manages the maintenance and repair process throughout the entire vehicle lifetime.

In several embodiments, the system comprises a vehicle return application or component, which can take the form of an application on a mobile computing device. The return application is used to process the return of a fleet vehicle, including the detecting and recording (such as by digital images or videos) of damage to the vehicle (internal or external), and the need for maintenance of one or more vehicle components or systems. In some embodiments, a smart vehicle detection and recording process is used.

The system then performs, in real time, an automated comparison of the vehicle condition against an established vehicle standard or standards, such as, but not limited to, a vehicle rentable standard or a vehicle operating standard. When the established vehicle standard is not met, the vehicle is automated placed “out of service.” If a rental fleet vehicle, for example, the vehicle then cannot be rented.

In several embodiments, a maintenance application allows the capture of maintenance and/or damage problems or issues that arise outside of vehicle rental or use, and thus would not be captured by the vehicle return process. The system then automatically creates an repair or maintenance order based on the vehicle condition information (including information gathered upon vehicle return, if applicable). The system may automatically direct a repair to the most cost effective supplier based on the total cost and other parameters of the repair, including, but not limited to, repair time, logistics, expenses, and similar factors.

### BRIEF DESCRIPTION OF THE DRAWINGS

FIG. 1 shows a view of a return and repair management portal process, in accordance with an embodiment of the present invention.

FIGS. 2-62 show views of a various user interface screens from a vehicle return mobile device application.

FIGS. 63-66 show views of user interface screen for a repair management portal application.

### DETAILED DESCRIPTION OF EXEMPLARY EMBODIMENTS

In various exemplary embodiments, the present invention comprises an improved system and related methods for management and control of fleet vehicle condition, maintenance, damage assessment and recovery, and repair. The fleet can be a rental vehicle fleet, shared vehicle, a corporate vehicle fleet, or other plurality of vehicles, including, but not limited to, automobiles, trucks, vans, buses, motorcycles, bicycles, and the like. The system provides a unique, single integrated platform, and manages the maintenance and repair process throughout the entire vehicle lifetime.

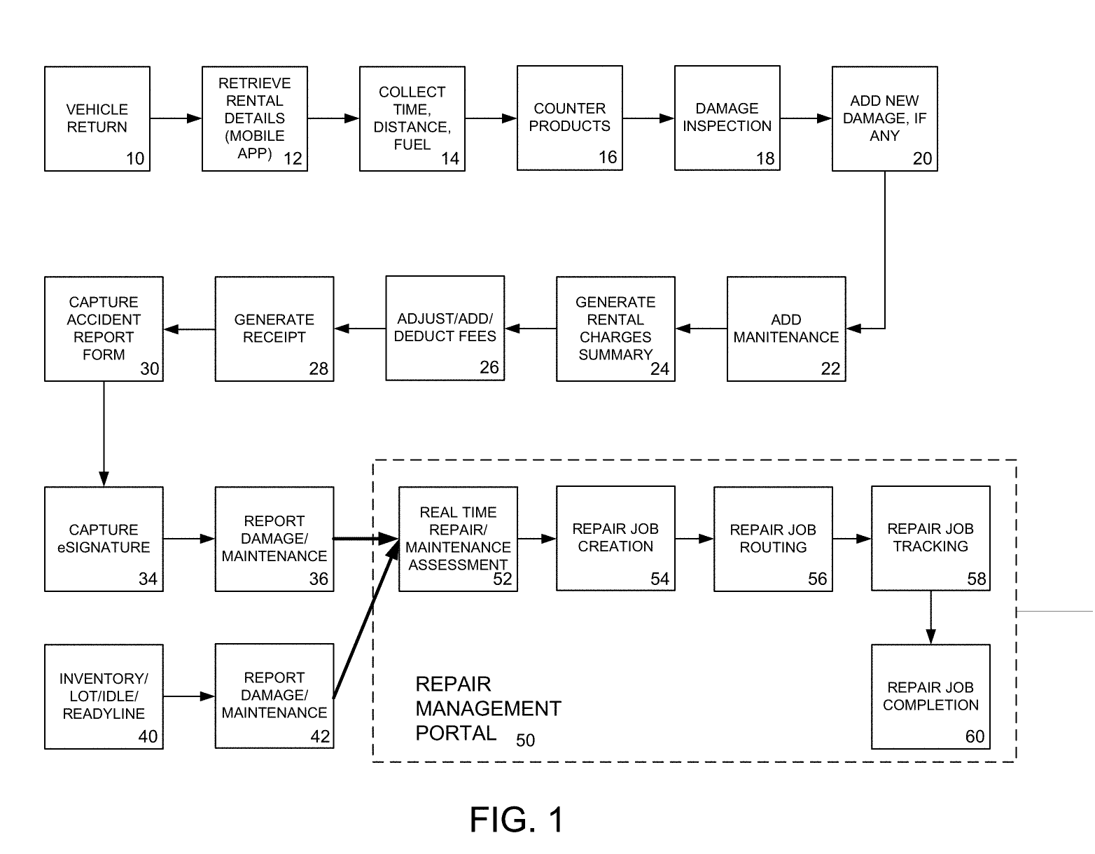

FIG. 1 provides an overview of one embodiment of the present invention, comprising a vehicle return application or component, which can take the form of an application on a mobile computing device. The return application is used to process the return 10 of a fleet vehicle. The user of the mobile device application identifies the vehicle and retrieves and review details 12 about the rental or period of use for the vehicle, collects current information about the vehicle (e.g., time of return, mileage, fuel status) 14, retrieves or collects any products or devices to be returned to the rental counter or to fleet storage 16, reviews pre-existing damage records and inspects for any new damage (interior or exterior) 18, documents and records any new damage 20, and identifies and adds any maintenance issues 22. Where the fleet is a commercial vehicle rental or sharing fleet, the user then generates a summary of the rental charges 24, adjusts the charges by adding or deducting appropriate fees 26, and generates a receipt 28. If there has been a vehicle accident or other incident resulting in damage to the vehicle, the user may also electronically capture an accident report form 30 (note that capturing an accident report form may take place elsewhere during the return process, or even after the return process has been completed). The user then closes out the return by capturing the eSignature of the driver or customer of the returned vehicle (or documenting the refusal of the driver or customer to do so) 34.

If there have been added damage and/or maintenance issues identified, then the damage and/or maintenance information is reported to the repair management portal 50 for real-time assessment 52. The system performs, in real time, an automated comparison of the reported vehicle condition against an established vehicle standard or standards, such as, but not limited to, a vehicle rentable standard or a vehicle operating standard. When the established vehicle standard is not met, the vehicle is automatically placed “out of service.” If a rental fleet vehicle, for example, the vehicle then cannot be rented.

The system then automatically creates an repair or maintenance job or order 56 based on the vehicle condition information. The system will then automatically route or direct 56 a repair or maintenance job or order to the most cost effective supplier based on the total cost and other parameters of the repair, including, but not limited to, repair time, logistics, expenses, and similar factors. The progress of the repair/maintenance job or order is automatically tracked and monitored 58 through completion 60, where the vehicle is inspected upon return for acceptance back into service (or other disposition).

While maintenance and damage problems or issues often arise during fleet vehicle rental or use, and are identified during the rental or use or during the return process, as described above, the system also may be used to identify, capture and report 42 damage or maintenance problems or issues that arise outside of vehicle rental or use, such as when a vehicle is idle, sitting on a lot, being inventoried, or being reviewed or assigned to a “readyline” for future disposition 40.

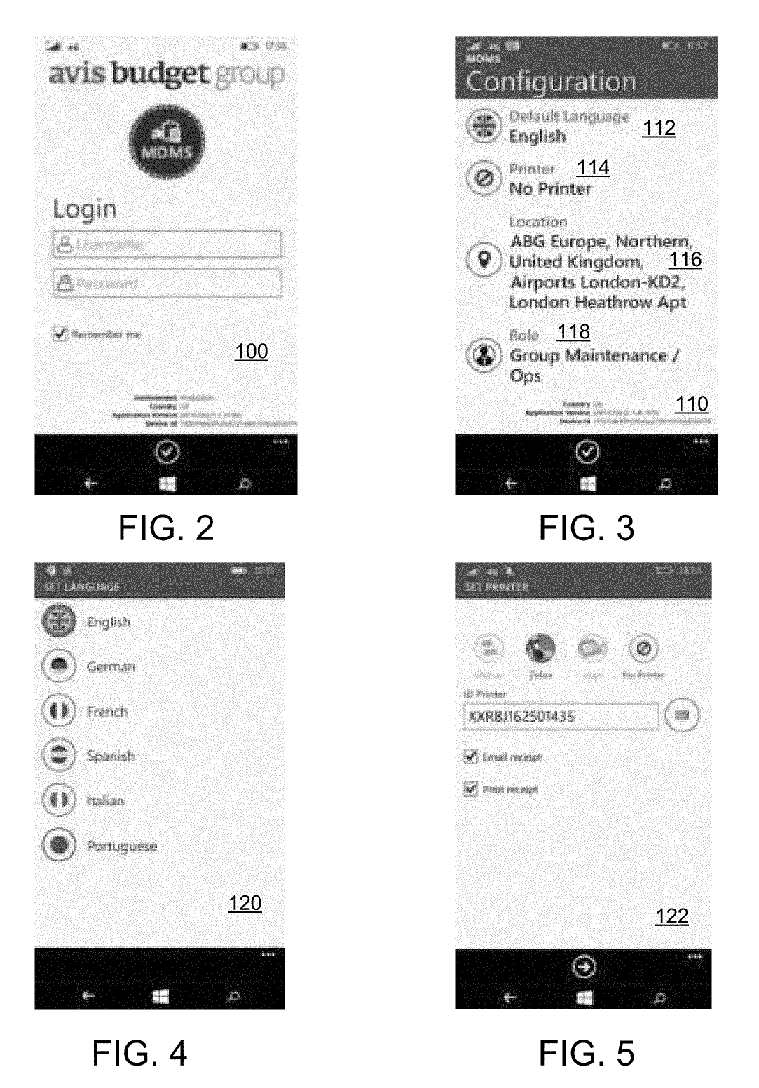

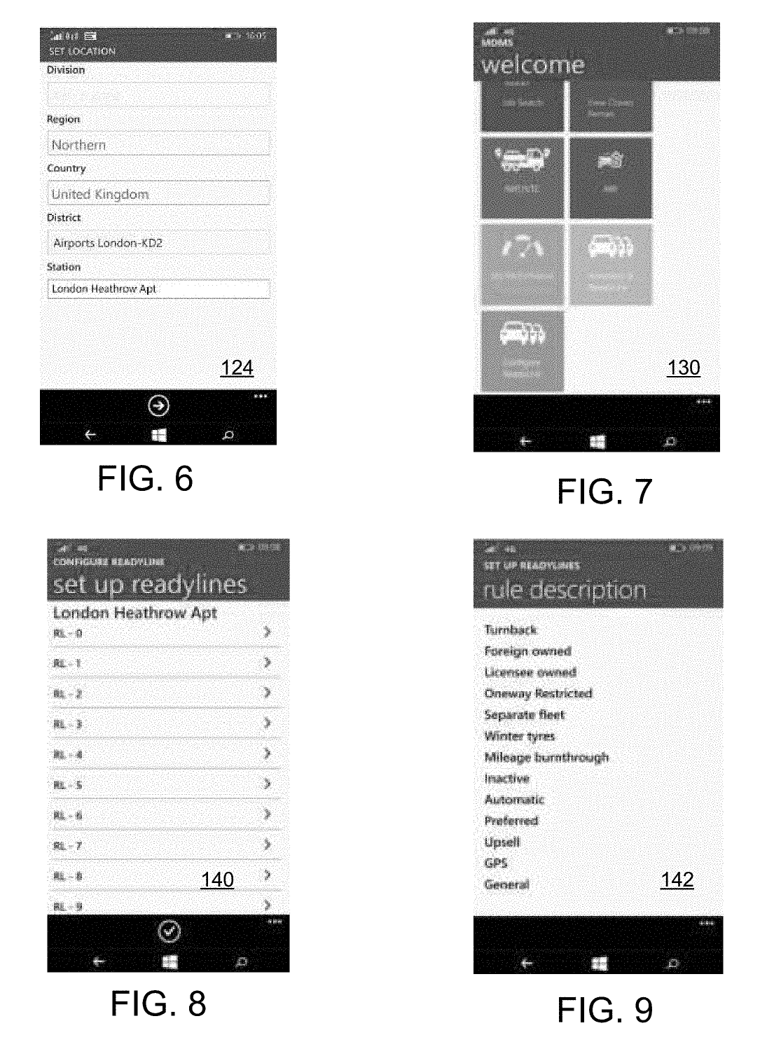

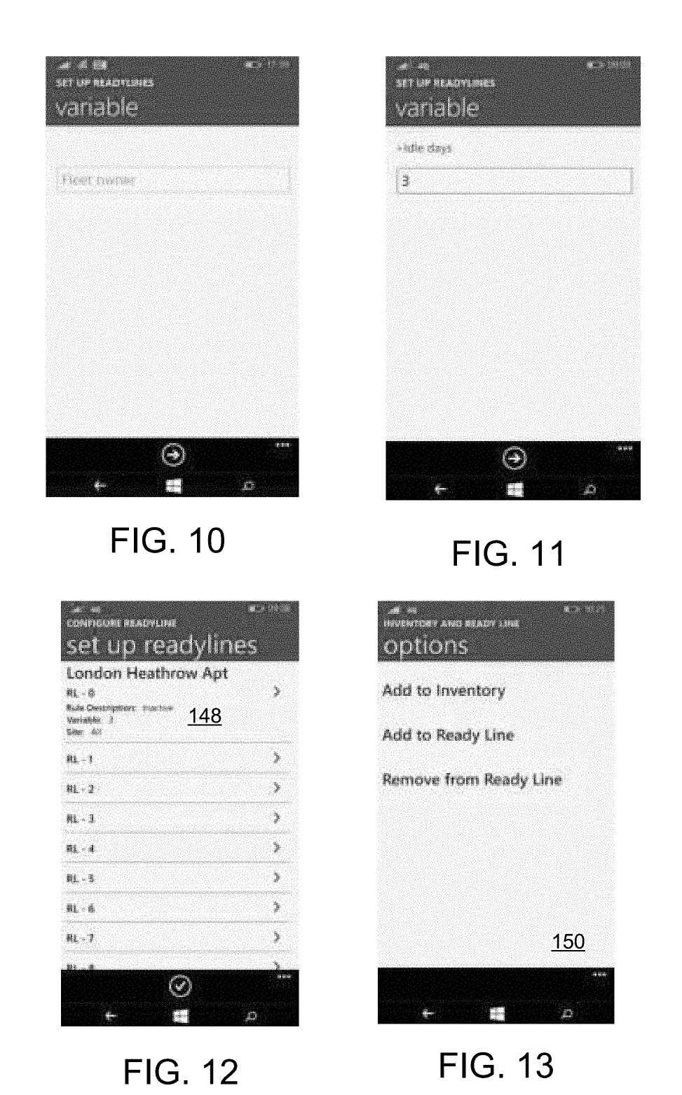

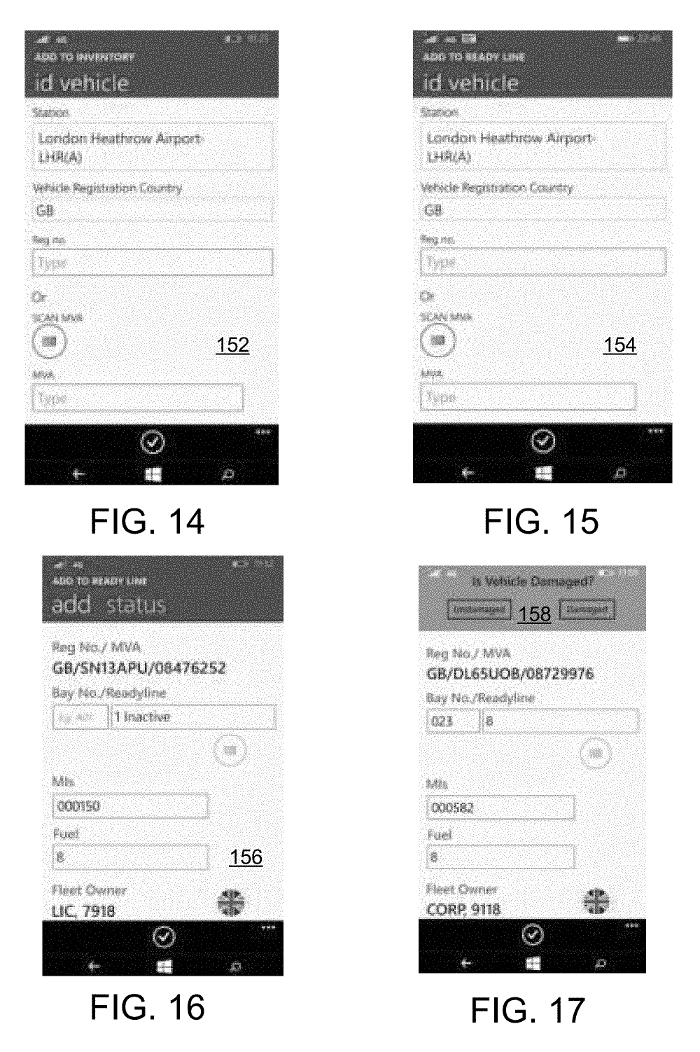

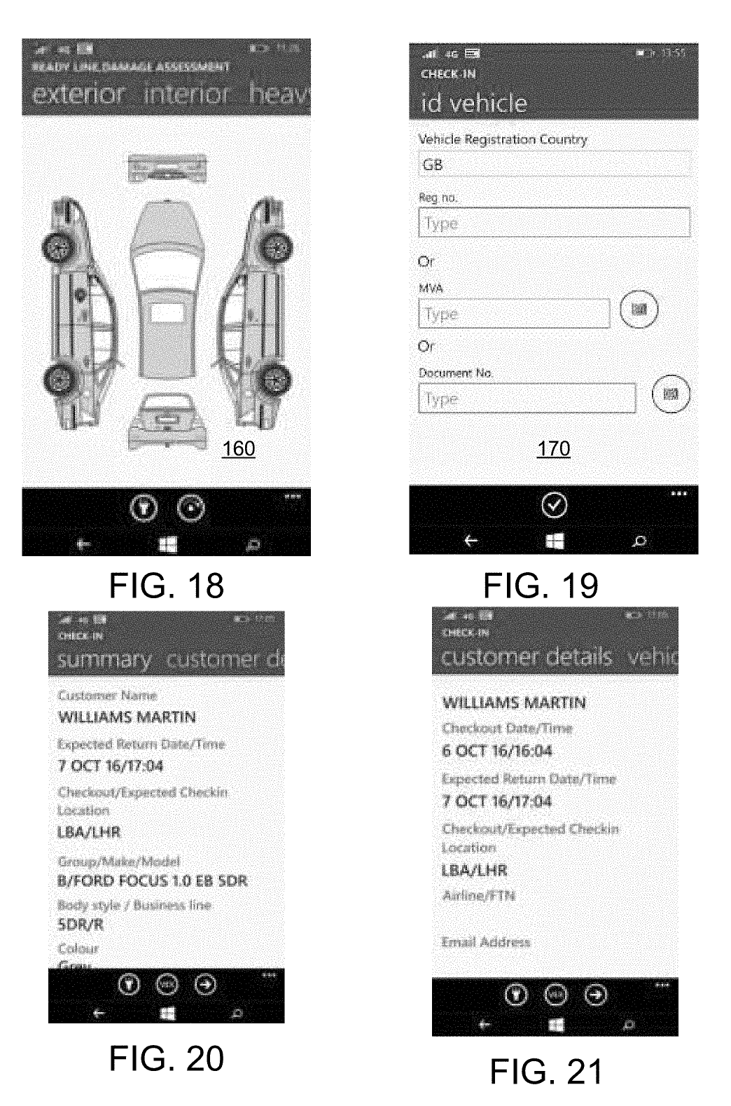

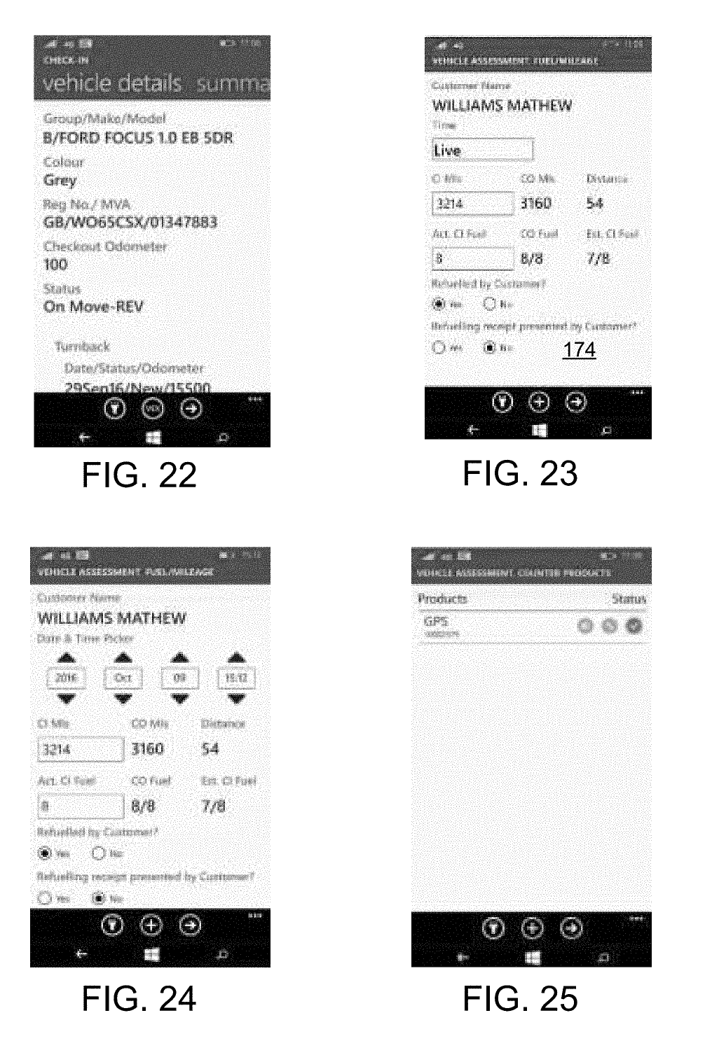

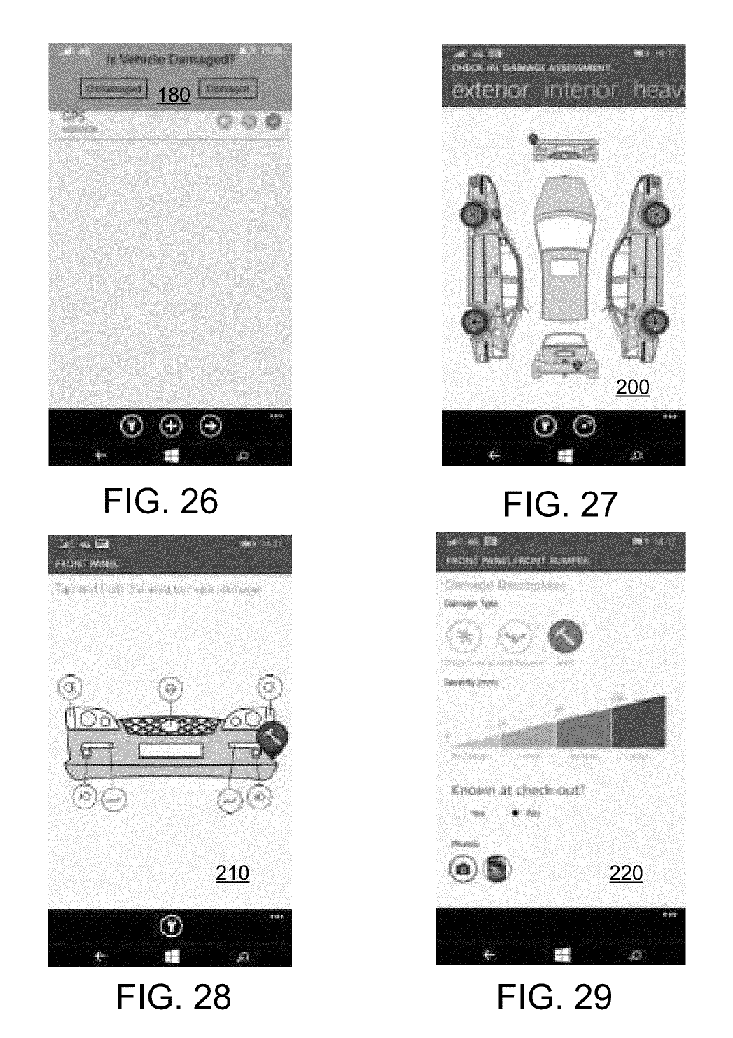

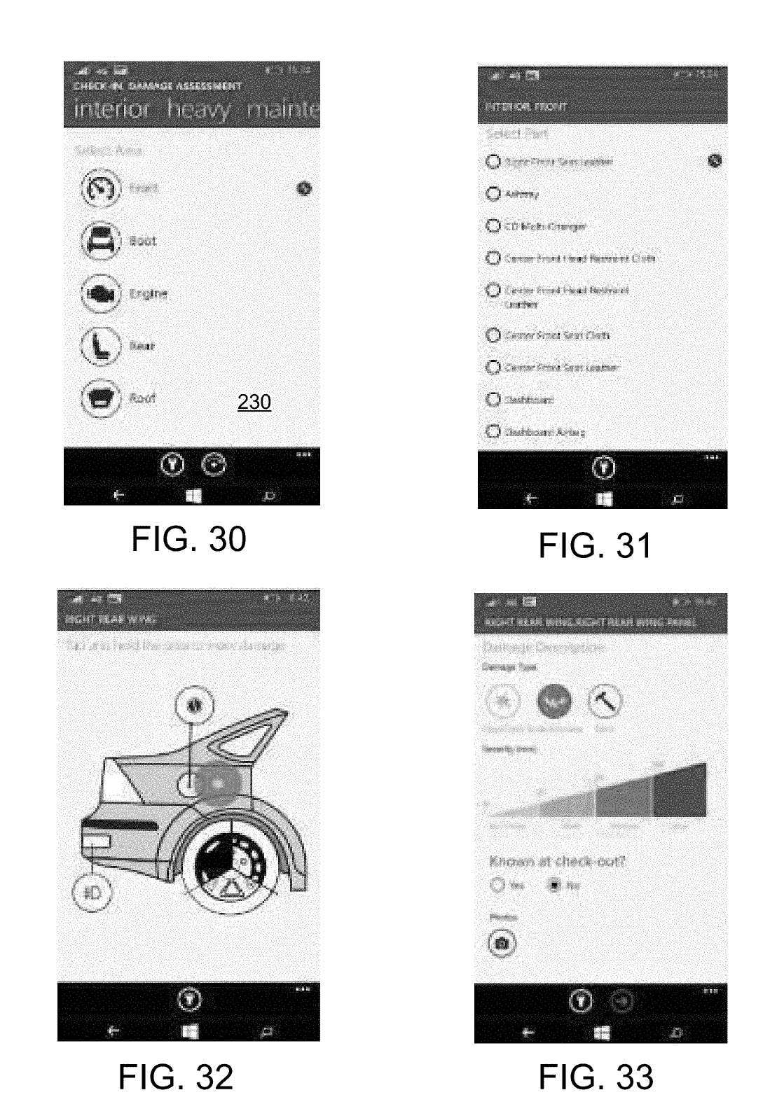

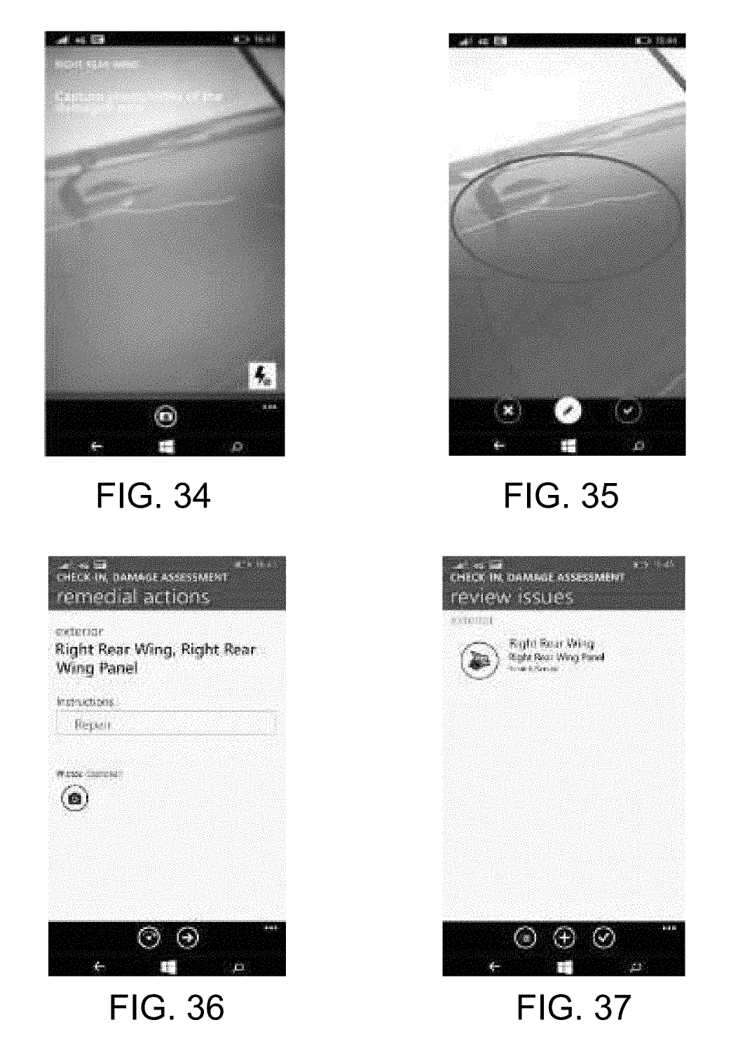

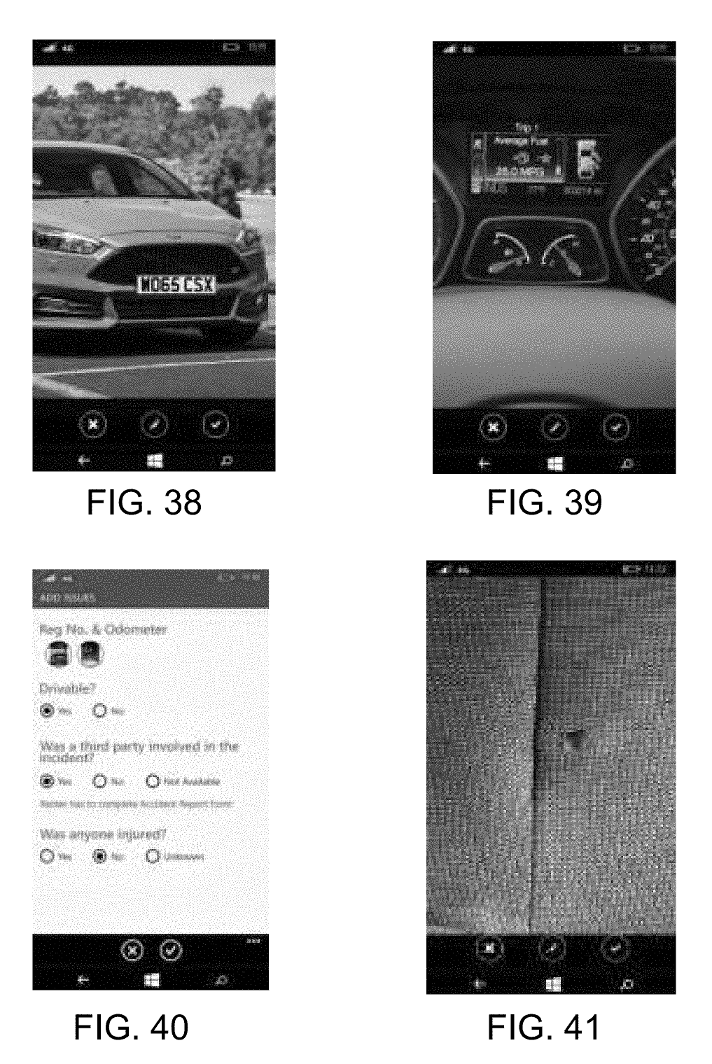

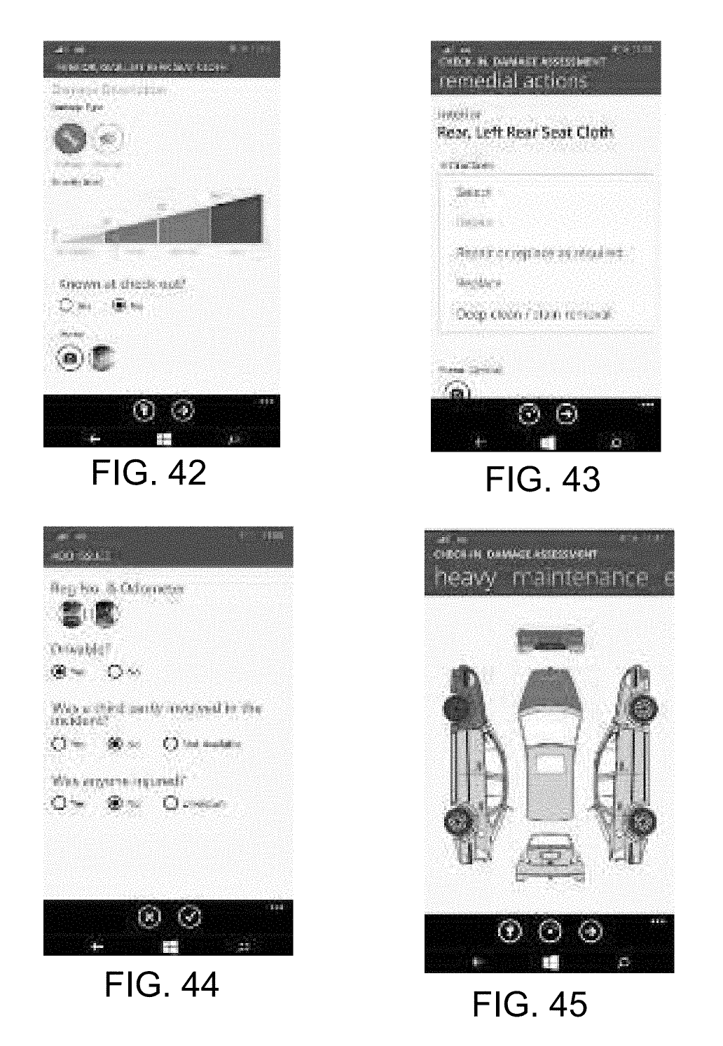

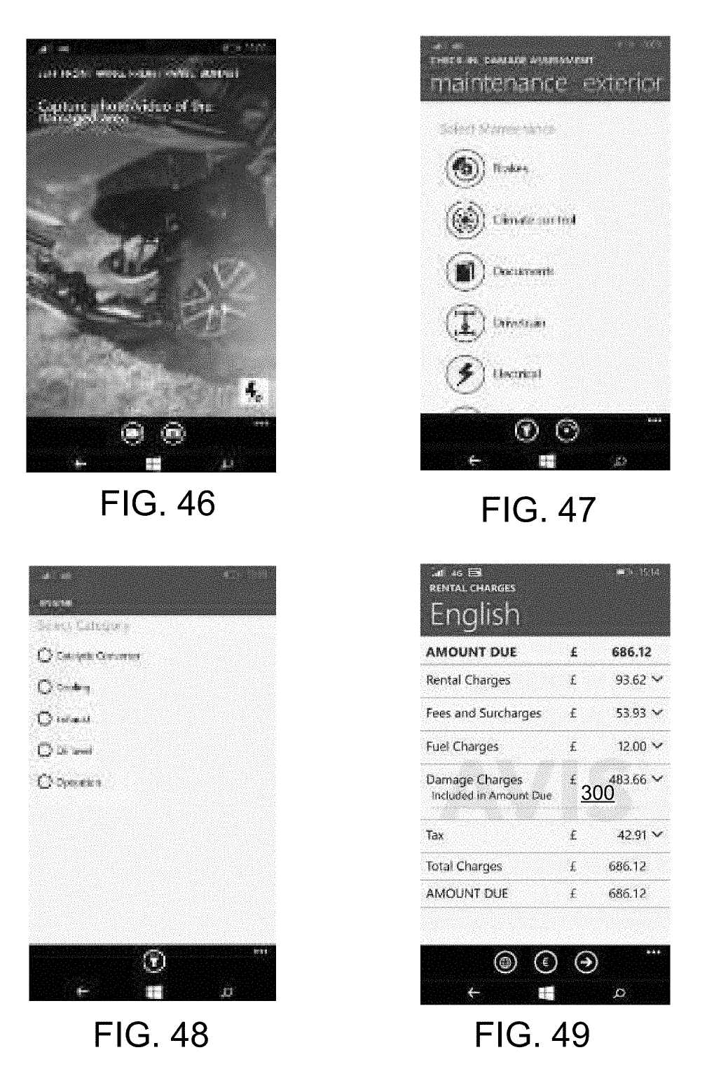

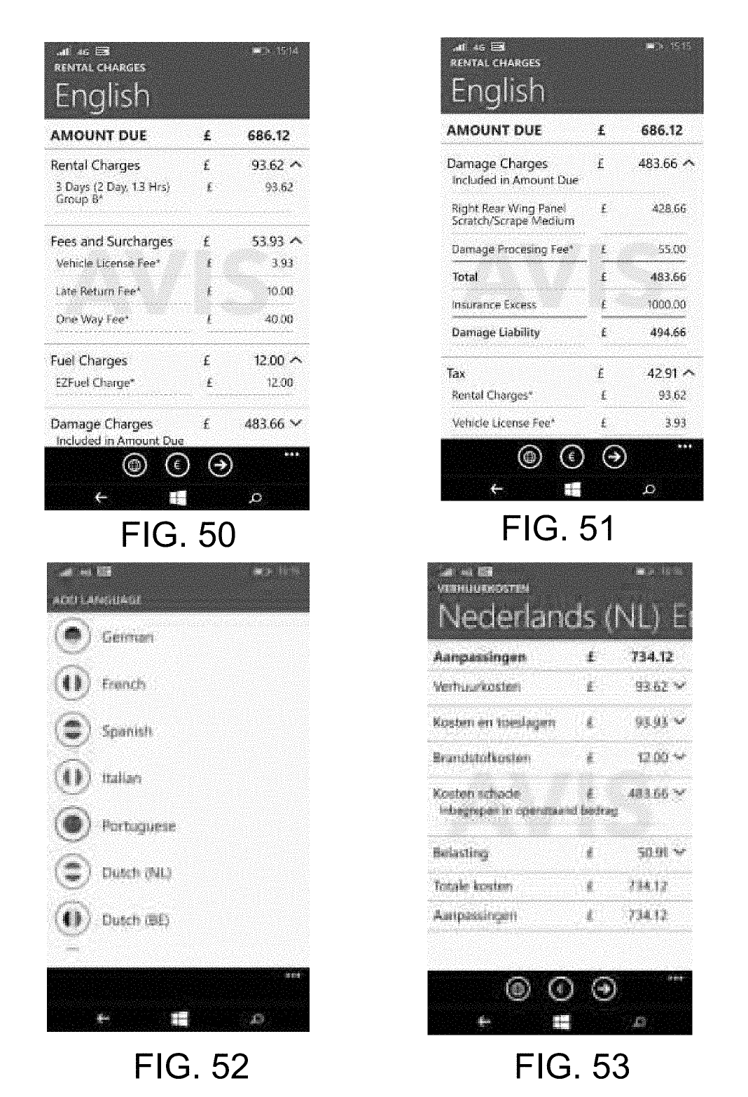

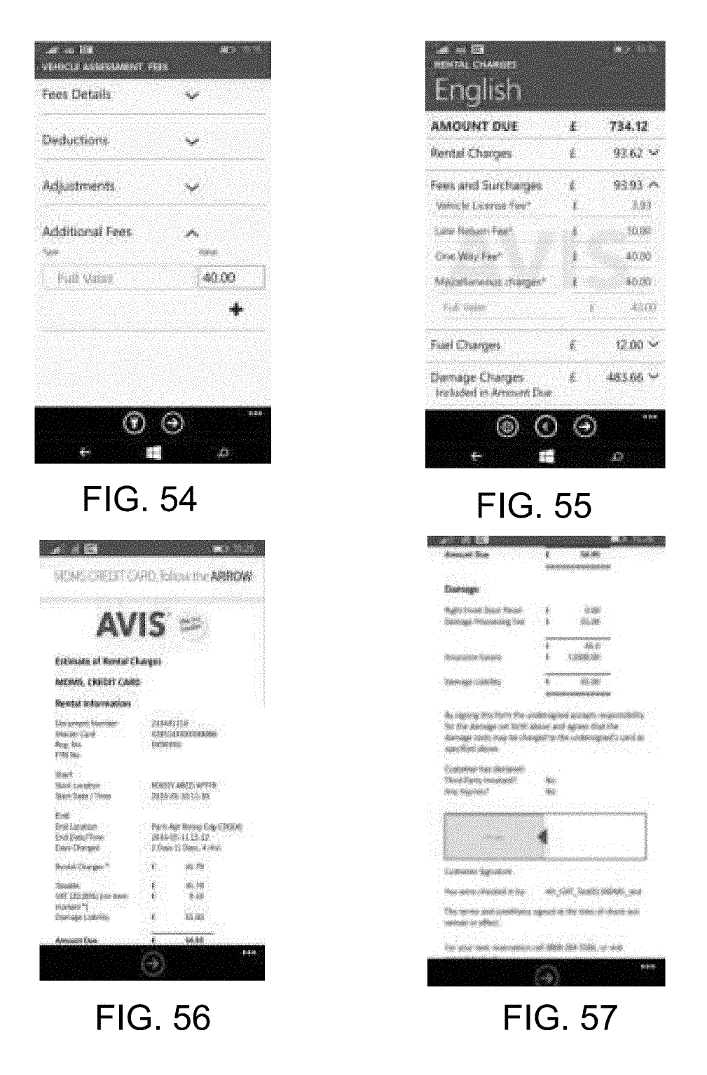

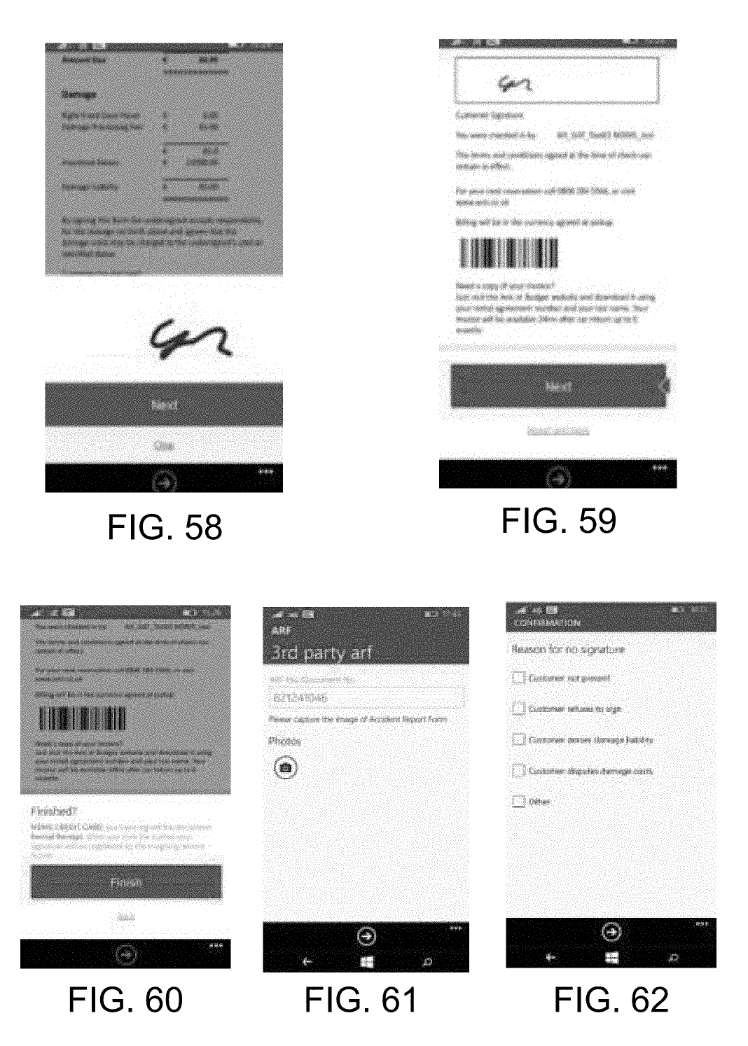

In several embodiments, a program or application for carrying out some or all of the above activities is provided on a user mobile device, such as described below. Running the application on a mobile device allows the user to carry out the activities in the presence of the vehicle. Exemplary mobile device user interface screens are seen in FIGS. 2-62. FIGS. 2 and 3 show examples of log-in 100 and base configuration 110 screens. Users may log in with a username and password, although additional or multiple factor authentication means (e.g., biometric confirmation) may be used for additional security. Log in is required for access to the configuration screen and other elements of the program, as described below. The log in, and other screens, For additional security, in several embodiments the password may not be changed by the user from the mobile device, but only through logging into the system server from a fixed computer device or terminal.

The configuration window identifies the applicable default language 112, printer 114, user location 116, and role of the user 118. The default language can be established based on the country of use. Clicking on the icon for the default language allows the user to set a different default language for the user application through a language selection screen 120, as seen in FIG. 4. Similarly, the user can select a printer (and whether to email and/or print receipts) through a set printer screen 122, as seen in FIG. 5. Selection of a printer can be made by typing in a printer ID (e.g., serial number, network identifier, or Bluetooth code) or scanning (using a scanner or camera in the mobile device) a barcode with the same or similar information on the printer. Users that have responsibility or access to multiple sites or locations may need to change the current location in the configuration window through a set location screen 124, as seen in FIG. 6. Changes in role may also be made in a similar manner.

FIG. 7 shows an example of a home page or “welcome” screen 130 for the application. Tiles or icons are displayed for each process available to the user. Processes may also be presented in alternative forms, such as menus, drop-down menu selections, lists, or the like. Certain processes are role specific, and only users with roles will see the corresponding process tile. Processes, include, but are not limited to:

Inventory & Readyline: allows users to add vehicles to the inventory and designated readylines, or remove vehicles from a readyline.

Configure Readyline: allows users with manager role to configure and create automated readyline rules.

Check-In: allows users to process vehicle returns from a rental or use.

Collection Check-In: allows users to process rental returns where the fleet owner or rental company collects the vehicle from the customer.

View Closed Rental: allows users to review charges and damages summary after a check-in is complete, and re-print receipt.

Damage Maintenance: allows users to identify and record maintenance and/or damage issues outside of the return process or that are not linked to a rental agreement.

To Do List: alerts users who have damage management responsibilities that action is required on a particular damage/maintenance job.

Job Search: allows users to search damage and/or maintenance repair jobs by various parameters (e.g., location, MVA, registration, job stage, and the like).

ARF: allows users to upload or capture an accident report form (ARF) outside of the return process.

NRT/VTC: allows the user to create a non-revenue transfer (NRT) or vehicle transfer contract (VTC) directly from the application.

Choosing a Configure Readyline option results in a readyline set up screen 140, as seen in FIG. 8. The user with a manager role can here set up one or more readylines, each with one or more associated rules 142 (as seen in FIG. 9). When a user subsequently selects the Inventory & Readyline option and desires to add a vehicle to a readyline, the applicable readyline or readylines (typically identified by number for a location or site) may be automatically selected or offered for selection, based on matching of applicable readyline rules to the vehicle to be added. For example, if a “3 day inactive” readyline has been set up, and vehicle to be added that has been idle for 3 or more days will be automatically allocated to that readyline. In several cases, some readylines may already be pre-assigned for a particular vehicle or connected vehicle, and may only be changed by users with certain roles.

Examples of rules include, but are not limited to, the following:

TurnBack: for vehicles that are beyond a certain age or mileage, or are otherwise eligible for being turned back (e.g., returned to an owner or licensor).

Foreign Owned: for vehicles with a foreign vehicle owner code, including foreign licensee vehicles.

Licensee Owned: for vehicles with a license owner based in same country as vehicle home location.

Oneway Restricted: for vehicles that cannot be rented or use one-way (i.e., must be returned to originating location).

Separate Fleet: for vehicles with a specific fleet owner (particularly of use for countries with different fleet owners).

Winter Tires: for vehicles with winter tires installed as accessory (e.g., have winter tire accessory code).

Mileage Burnthrough: for vehicles that exceed a certain average daily distance, and thus are likely to exceed turnback mileage before reaching a turnback date (typically based on age).

Inactive: for vehicles that have been inactive for a certain number of days.

Automatic: for vehicles with automatic transmission.

Preferred: for particular low mileage vehicles for preferred customers or users.

Upsell: for vehicles of a particular manufacturer, or with particular accessories, or combination there.

GPS: for vehicles with GPS device or accessory.

General: a fallback or default readyline for vehicles that do not match any rule for any other defined readyline.

Readylines for a particular location or site or fleet can be assigned a priority or a position in a hierarchy (for example, the readyline list above can be considered in order of high priority to low priority). When a vehicle meets the criteria of more than one readyline, in such cases it can be assigned by default to the highest priority readyline.

Various rules, including, but not limited to, several of those identified above (e.g., TurnBack, Oneway Restricted, Separate Fleet, Mileage Burnthrough, Inactive, Preferred, Upsell), may require defining additional variables as part of the set up process. Upon selecting a rule requiring variable input, the appropriate variable input screens are displayed, as seen in FIGS. 10-11 (e.g., asking for fleet owner selection or input, number of idle days for inactive, average daily mileage for burnthrough, maximum mileage for preferred, specific accessories, or vehicle makes or models). Multiple rulesets can be added to the same readyline, or separate readylines can be set up, each with an applicable rule set. For example, a single Upsell readyline could include all Audi, BMW and Mercedes vehicles, and any other make with a navigation unit. In comparison, two Upsell readylines could be created, one with the Audi, BMW and Mercedes makes, and the other with any vehicle with a navigation unit. As a further example, an Upsell readyline could be limited to Audi, BMW, and Mercedes vehicles that also have a navigation unit. Upon completing input for the selected rule(s), the readyline set up screen 140 is updated with applicable rule information 148 for that readyline, as seen in FIG. 12. After creation, readylines can be deleted or modified in a similar manner through the application.

As noted above, a user can use the Inventory & Readyline process to add vehicles to the inventory and/or automated readylines. Selecting this process shows the Inventory and Readyline option input screen 150, as seen in FIG. 13. Options including adding the vehicle to inventory, adding the vehicle to a readyline, or removing the vehicle from a ready line.

Selecting the add to inventory option provides the vehicle identification screen 152 (FIG. 14), which allows a user to add a vehicle to the inventory for a particular location, site, or station. The user can change the inventory location by clicking on the station field, and selecting the invention location from a list, drop-down menu, or map. The user can identify the vehicle by entering or selecting the country of registration, entering or selecting the make or type of vehicle (if necessary), and entering the vehicle registration number or code of Motor Vehicle Administration number or code (by typing in the field, or by scanning a barcode on the vehicle with a scanner or camera in the mobile device). A confirmation message is displayed on the screen upon successful addition of the vehicle to inventory.

Selecting the add to readyline option provides the vehicle identification screen 154 (FIG. 15), which operates in a similar fashion to the corresponding screen for the add to inventory option for selecting station, registration numbers, and so on. After the vehicle is identified, for locations that have set up automated readylines, the appropriate readyline identifier (which can be a number, name, or some alphanumeric descriptor) is automatically selected based on application of the rule set(s), as seen in the readyline add status screen 156 in FIG. 16. The user enters the current vehicle location (i.e., bay number, lot slot number, or the like) in the appropriate field (e.g., the Bay No. field). For locations that have not set up automated readylines, the user is prompted to enter the location (e.g., Bay No. field) and select a readyline from a list provided by tapping on the readyline field. The user confirms that the preloaded vehicle information (e.g., mileage, fuel reading) are correct, then proceeds by clicking the confirmation icon on the screen (the check mark in a circle in the screens shown in the figures, although other icons may be used).

Adding a vehicle to a readyline also prompts a damage update. If there is no pre-existing damage recorded against the vehicle, then the user is next prompted to confirm whether the vehicle is damaged or not 158 (FIG. 17). The undamaged option is selected if the user confirms that the vehicle is undamaged, while selection of the damaged option takes the user to the damage assessment input screen 160 (FIG. 18). If there is existing damage recorded against the vehicle, the user is taken directly to the damage assessment input screen 160. The user then performs a damage and/or maintenance assessment (as described below for damage assessment and recording during the check-in process), and completes the adding or updating of the damage information. A confirmation message is displayed on the screen upon successful addition of the vehicle to a readyline.

Vehicles can be removed from a readyline through a similar process to adding them. The user identifies the vehicle, and confirms removal from the associated readyline.

A user can use the Check-In process or option to process the return of a vehicle after rental or use, and close the rental. It can also be used to process the delivery or return of an NRT or VTC vehicle (as discussed below). The first step is to identify the vehicle and retrieve the rental details through the vehicle identification screen 170 (FIG. 19). The user can identify the vehicle by entering or selecting the country of registration, entering or selecting the make or type of vehicle (if necessary), and entering the vehicle registration number or code of Motor Vehicle Administration number or code (by typing in the field, or by scanning a barcode on the vehicle with a scanner or camera in the mobile device). Alternatively, the user can identify the rental by entering a rental agreement number or code in the document number field (by typing in the field, or by scanning a barcode on the document with a scanner or camera in the mobile device).

Completing this input results in the summary display of details about the customer rental and vehicle (see FIGS. 20-22), for confirmation by the user. When the vehicle is returned late, or returned early more than a pre-set time (e.g., 24 hours), the expected return date/time filed may be highlighted with an appropriate color or icon to draw the attention of the user. Similarly, where the return location differs from the expected check-in location, the location field by be highlighted with a color or icon or otherwise marked. Depending on the device, the user can scroll up or down, or right or left (e.g., by “swiping”), to move between screens or parts of screens.

The user is then prompted to enter updated vehicle information, e.g., odometer and fuel gauge readings, on the appropriate vehicle assessment screen 174 (FIG. 23). If the vehicle is subject to or is qualified for a fuel refueling package, additional information about refueling (e.g., confirm whether customer refueled, confirm whether customer presented fuel receipt) may be solicited. If the user needs to performed a delayed check-in, the user taps the time field to display a date and time picker/selector (FIG. 24), and enters the required check-in date and time. If counter products have been rented, the user then reviews the devices or products, and confirms whether they have been return in an acceptable condition, are missing, or are damaged by selecting the appropriate icon or button for each item (see FIG. 25)

The vehicle return process then prompts a damage update. If there is no pre-existing damage recorded against the vehicle, then the user is next prompted to confirm whether the vehicle is damaged or not 180 (FIG. 26). The undamaged option is selected if the user confirms that the vehicle is undamaged, while selection of the damaged option takes the user to the damage assessment input screen 200 (FIG. 27). If there is existing damage recorded against the vehicle, the user is taken directly to the damage assessment input screen 200.

The damage assessment screen provides exterior, interior, and “heavy” damage in appropriate display. FIG. 28 shows the exterior damage with different views or “panels” of the vehicle, typically a left side, top, right side, front, and back views. An icon or specific color can be used to indicate the presence and location of pre-existing damage, if any. This allows the user to assess what damage visible on the vehicle is pre-existing, and what, if any, is new.

Tapping on a panel view provides an enlarged or close-up panel display 210 for that panel (see, e.g., FIG. 29). Damage icons are used to indicate the present and location of specific damage. Tapping on the icon provides a damage description and details screen 220, with indications of damage type, severity, part damage, and the like. An image thumbnail is presented if a picture or video of the damage is available (accessed by tapping on the thumbnail).

Pre-existing interior damage can also be reviewed. FIG. 30 shows a display 230 of interior damage by five main vehicle areas (front/console, boot/trunk, engine, rear, roof). Icons similar to those use for exterior damage are used to indicate if damage exists in an area. List text can also be colored or highlighted to indicate the presence of damage in that area. Tapping on the icon provides more details about the location of the damage, as seen in FIG. 31.

The user uses these screens to add new damage to the exterior or interior as well. The exterior damage screen generally is used to record individual items of damage to the vehicle's exterior. If a vehicle has sustained heavy or substantial damage to multiple panels or areas, the “heavy damage” option may be used.

To record new damage, the user taps the area of the vehicle is located to open up the appropriate exterior panel or interior area location list. The exact location of the damage to be added is then indicated by tapping and holding the relevant part of the panel or list entry, as seen in FIG. 32. The user can zoom in or out of the panel image as needed by the usual means for the device (e.g., pinching or spreading fingers on the screen) for precise location of the damage.

This opens the damage input screen, as seen in FIG. 33. The user provides information about the type of damage (e.g., chip, scratch, dent), the severity of the damage, where appropriate (i.e., some types of damage, such as a missing item, do not require severity), and other input. Photos or videos also should be taken for all new damage recorded, using the camera or video devices in the mobile device. Pressing on the camera icon on this screen activates the camera, which is operated using device controls.

In picture mode, a picture of the damage can be taken and displayed for review, as seen in FIG. 34, and annotated using the pen or pencil icon to highlight the damage with a finger or stylus to draw a circle or other annotation, as seen in FIG. 35. Clicking on the confirmation icon saves the image (or where video is taken, the video data is saved). At least two pictures should be taken for each damage issue, including a close-up focusing on the damage, and a second image capturing the whole body panel.

For certain types of damage, the user must confirm remedial action instructions, as seen in FIG. 36. Tapping on the instructions box allows the user to select appropriate actions from a list, drop-down menu, or the like. A summary review issues screen provides a summary of all issues recorded. A particular issue can be amended or deleted from this screen, as seen in FIG. 37. Additional issues can be added and recorded by the add icon. Once all issues are recorded, the confirmation icon is selected to proceed. The user is then prompted to capture an image of the vehicle registration in context with the location of the vehicle (to show where the vehicle is located at the time), as well as an image of the odometer reading (see FIGS. 38-39). This to help establish where and when the damage was recorded.

If there was an identifiable accident or incident associated with the damage, the circumstances of the incident should be recorded (FIG. 40). Assessment includes, but is not limited to, whether the vehicle is drivable, whether a third party was involved, or whether there were any injuries.

New interior damage is added in a similar way using the interior area and part selection screens previously described. As with exterior damage, the user is prompted to take pictures and/or video, record the location of damage, record the type and severity of damage, and capture incident circumstances (see FIGS. 41-44).

As noted above, if a vehicle has sustained heavy or substantial damage to multiple panels or areas, the “heavy damage” option may be used. This allows the user to record substantial damage spanning multiple panels. To indicate damaged panels, the user taps on the panel in the display, which turns that section of the panel to a color to indicate general heavy damage, as seen in FIG. 45. As with other exterior damage, additional information is collected, with photos and videos of the damage recorded (see FIG. 46). Maintenance issues also can be added. FIG. 47 shows a maintenance input screen, which provides a general list of maintenance issues by category to be added by selection. For some maintenance selections, further information is solicited (see, e.g., FIG. 48). Taking images or video is optional for maintenance issues.

After damage and maintenance issues, if any, have been recorded, the application display a charges summary screen 300, as seen in FIG. 49. In additional to rental charges, fees and surcharges, fuel charges, and tax, this screen also displays a damage charge. This damage charge is automatically calculated in real time upon completion of the recording of all damage issues. The damage charge for one or more damage items may be based upon the application of a set of damage assessment and evaluation rules that determine the appropriate damage charge as an estimated or expect repair charge, based on a plurality of factors, including, but not limited to, the vehicle make, vehicle model, vehicle year (i.e., age), vehicle mileage, whether the vehicle has been previously damaged, the location of the damage, the type or classification of the damage, the severity of the damage, the location of the vehicle, the likely location of any repairs to be performed, the recent (for a set period of time) history of actual repair costs for the same or similar damage (i.e., type, classification, location, severity) to the same or similar vehicles (i.e., make, model, year, mileage), the current and expected status of the vehicle, the assigned readyline, the vehicle owner, and the nature and timing of the ultimate vehicle disposition.

The provision of a damage charge in real time at the time of check-in allows the customer to accept and pay for the damages incurred during the rental at that time, and allows the rental fleet owner or operator to close the rental contract early without further dispute or having to keep the rental contract open for resolution. This lowers overall operational and administrative costs, and increases the efficiency of managing the fleet vehicles as a whole.

As seen in FIGS. 50-51, the user can obtain more detailed displays of any of the charges, allowing the user to run through the charges (including damages) line by line with the customer, if desired. The language of the charges displays can be changed to accommodate the language of the customer, without changing the default language of the application itself for the user (FIGS. 52-53). This selection also will change the language of the customer's receipt. Depending on the user's role, the user may apply deductions, adjustments, and/or additional fees (FIG. 54). These changes are then reflected in an updated charges summary (see FIG. 55).

The user then presents the device with final receipt to the customer for review and acceptance (by eSignature means or otherwise), as seen in FIGS. 56-59. Clicking on the signature box allows them to sign on the screen, and press next to register their signature. The customer then selects finish (FIG. 60) to confirm acceptance of the charges and save their signature. The signature is registered, and the electronic receipt uploaded directly to the system servers. A receipt can be emailed to or printed for the customer, as desired.

As discussed above, an accident report form (typically required when a damage incident involving a third party is recorded) may be captured at several points during the process, including, but not limited to, after obtaining the eSignature of the customer. As seen in FIG. 61, the accident report form, and supporting documents (e.g., police report, third party insurance cards) may be scanned or imaged by the scanner or camera in the device, and associated with the vehicle data. As discussed above, the accident report also can be uploaded or captured after the check-in process has been completed and closed.

In cases where the customer is not present at check-in (e.g., the check-in is a delayed transaction for an out-of-hours, drop-off or semi-automated return), or declines to sign the receipt, the signature capture process is skipped. The user selects the reject option at the signature screen, confirms the rejection, and selects the appropriate reason why no signature has been recorded (see FIG. 62).

Vehicle exchanges can also be accomplished through the Check-In option. The user completes the applicable check-in processes, including damage assessment, collects additional information (such as the reason for the exchange), then identifies and provides a replacement vehicle to the customer.

Independently, or as an addition to the above application, a facility or lot exit or entrance is equipped with a plurality of cameras configured to automatically record high definition video data or a series of still photographs whenever a vehicle passes through that entrance or exit. The cameras are positioned to record video or images of the front, back, both sides, and top of the vehicle, in sufficient detail to record any external damage at the time of passage. The recorded information is dated and time-stamped, and also show the vehicle or registration plate of the vehicle for positive identification. The data is transmitted by wired or wireless communications to storage servers, where it is retained for subsequent analysis. The stored data can be used to document any damage to a vehicle at the beginning of a rental (i.e., when it leaves the lot) and the damage to the vehicle when return (i.e., when it enters the return or check-in area), thereby resolving any disputes over the pre-existing conditions, or whether damage to a vehicle was caused during the rental. This system also may be used in conjunction with the above-described application as part of an automated or semi-automated return. The return images are analyzed and compared to the start images to detect the presence or location of any new damage to the vehicle upon return. The image and damage analysis can be performed automatically, and damage charges calculated as discussed above.

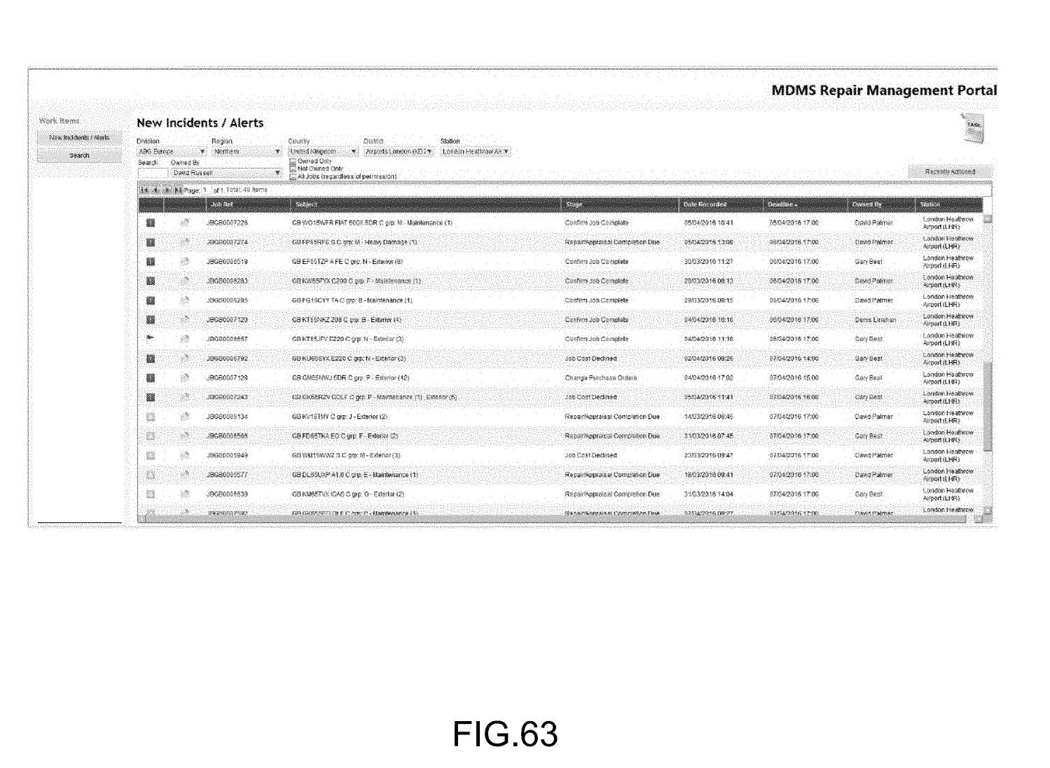

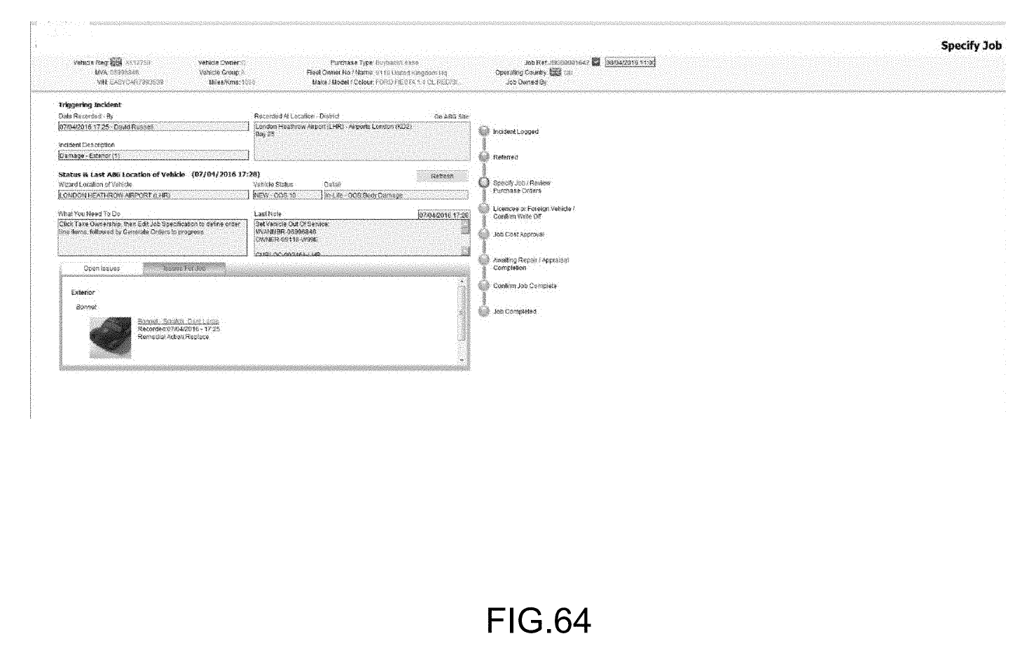

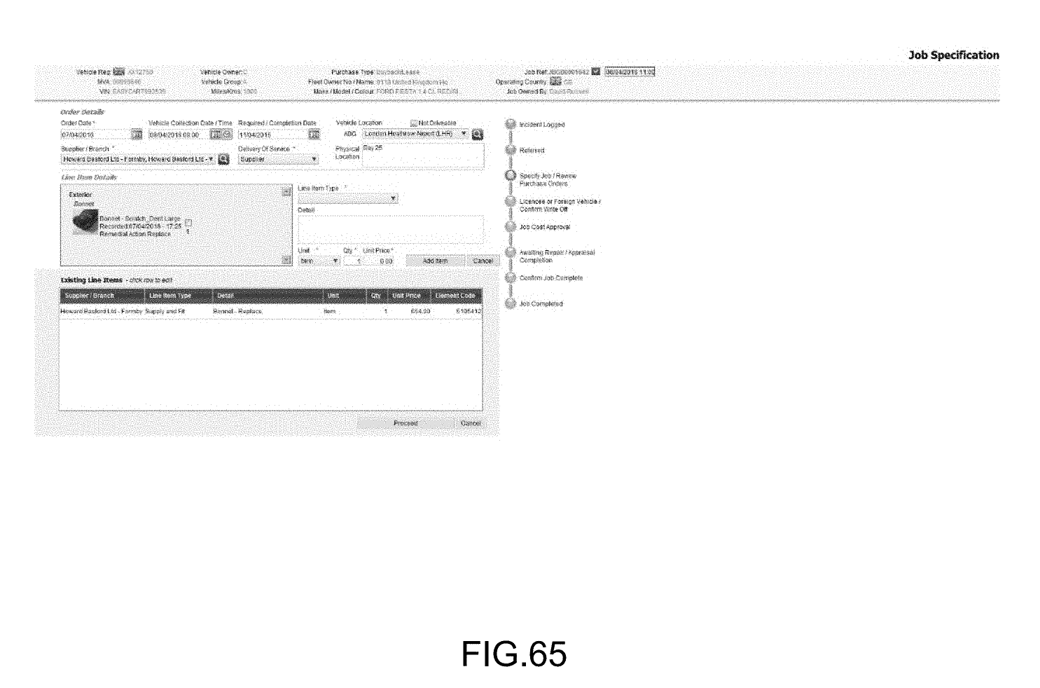

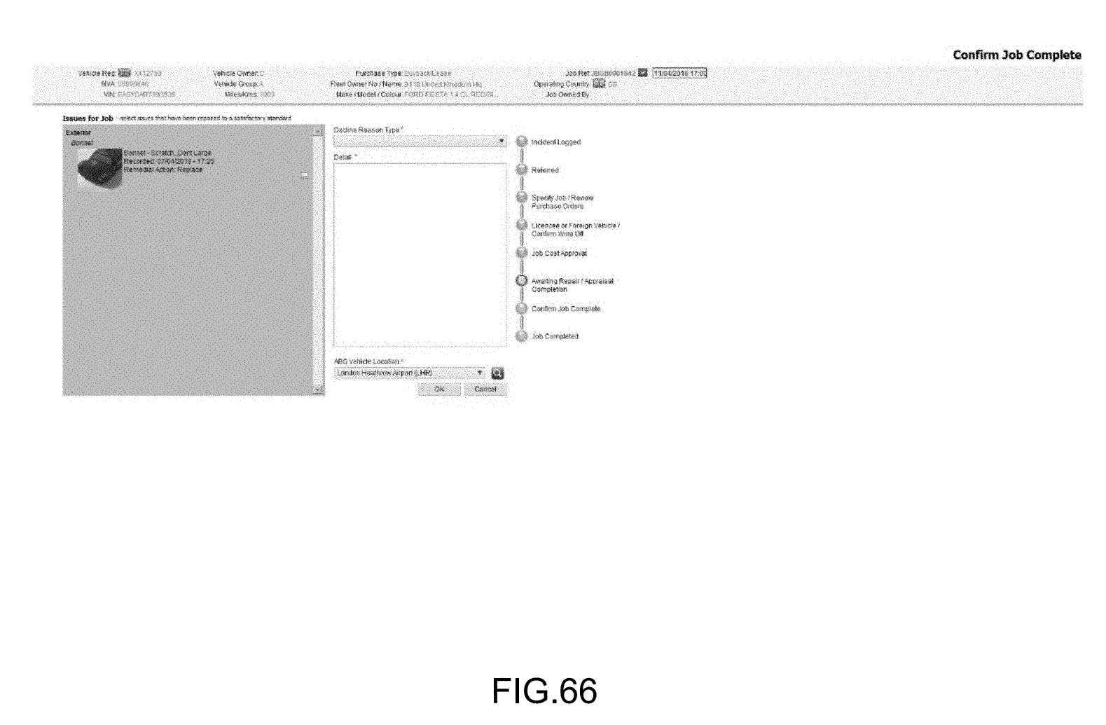

Any vehicle repair/maintenance issues may be managed through the repair management portal (as seen in FIGS. 63-66). The system allows users to obtain quotes for work, review and execute work and purchase orders (see FIGS. 64-65), review and approve invoices (including e-invoices), evaluate supplier performance, and similar tasks. The system can prepare and display a prioritized “to-do” list of maintenance and repair tasks (as seen in FIG. 63), and track all work performed and completed (including, but not limited to, a post-repair or post-maintenance inspection, as seen in FIG. 66). Documentation of system tasks and functions is maintained automatically.

The system can automatically decide the order of repair or maintenance (e.g., what gets repaired, when it gets repaired, and how it gets repaired) by application of a set of prioritization and cost rules. The system also can interact with business operation systems (such as a rental fleet management reservation system) to tactically address and possibly release additional vehicles at peak times as needed.

The system of the present invention thus provides significant advantages over the prior art. It allows the ability to track vehicle condition at each vehicle movement or check-points, and helps avoid missed damage and damage charges. It avoids the manually-intensive and inefficient rekeying of incident and damage details multiple times, thereby providing an efficient system to track and manage vehicle damage repair. It speeds the overall repair process, particular removing inefficiencies caused by delayed handover of vehicles to various members of the supply chain. It further provides a consistent standard for vehicle rental or operating condition, which can be automatically determined, resulting in an improved customer experience.

These embodiments, as well as other exemplary embodiments, as well as the tools and programs referenced above, are described in detail in the appendices attached to U.S. Provisional Applications Nos. 62/475,449 and 62/475,527, which are incorporated herein in their entireties by specific reference for all purposes.

In order to provide a context for the various computer-implemented aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), tablets, smart phones, touch screen devices, smart TV, internet enabled appliances, internet enabled security systems, internet enabled gaming systems, internet enabled watches; internet enabled cars (or transportation), network PCs, minicomputers, mainframe computers, embedded systems, virtual systems, distributed computing environments, streaming environments, volatile environments, and the like.

Embodiments of the invention may be implemented in the form of computer-executable instructions, such as program code or program modules, being executed by a computer, virtual computer, or computing device. Program code or modules may include programs, objects, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices such as, but not limited to, hard drives, solid state drives (SSD), flash drives, USB drives, optical drives, and internet-based storage (e.g., “cloud” storage).

In one embodiment, a computer system comprises multiple client devices in communication with one or more server devices through or over a network, although in some cases no server device is used. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

1. A method for improved fleet vehicle maintenance and repair, comprising:
receiving, from a mobile device, information about the condition of a returned fleet vehicle, wherein said information includes one or more digital photographs or videos of damage to said vehicle;
automatically comparing the condition information to a pre-established rentable vehicle standard; and
when the pre-established rentable vehicle standard is not met, automatically placing the vehicle in out-of-service status.

2. The method of claim 1, further comprising sending the vehicle and condition information to a repair portal application on a computer server.

3. The method of claim 2, wherein the repair portal application is configured to automatically creating a repair order for the vehicle, and determining a repair supplier for repairing the vehicle pursuant to the repair order based upon the repair time, logistics, and repair costs.

4. The method of claim 1, wherein the fleet vehicle is an automobile, truck, van, bus, motorcycle, or bicycle.

5. The method of claim 1, wherein the fleet is a rental vehicle fleet, shared vehicle fleet, or corporate vehicle fleet.

6. A method for improved fleet vehicle maintenance and repair, comprising:
providing a plurality of vehicles in a fleet;
providing one vehicle of said plurality of vehicles to an authorized user for use during a period of time, wherein said one vehicle is returned at the end of the said use;
during the return of said vehicle, receiving on a mobile device with a microprocessor, a storage device, and a camera, information about the authorized user, said vehicle, and the condition of said vehicle at the beginning of the period of use, including any pre-existing damage to the interior or exterior of said vehicle;
during the return of said vehicle, entering information about new damage to the interior and/or exterior of the vehicle, wherein new damage excludes pre-existing damage; and
if there is damage to the exterior of the vehicle, using the camera of the mobile device to take one or more digital photographs or videos of said exterior damage to said vehicle.

7. The method of claim 6, further comprising the steps of
automatically, in real time, calculating a damages charge for said new damage; and
presenting, during the return of said vehicle, a summary of charges to the authorized user for acceptance and confirmation of payment, wherein the summary of charges include said damages charge.

8. The method of claim 6, wherein the vehicle is an automobile, truck, van, bus, motorcycle, or bicycle.

9. The method of claim 6, wherein the fleet is a rental vehicle fleet, shared vehicle fleet, or corporate vehicle fleet.

10. The method of claim 6, further comprising transmitting, from the mobile device, the information about the condition of the returned vehicle to a repair management system.

11. The method of claim 10, wherein the repair management system is configured to automatically create a repair order for the vehicle, and determine a repair supplier for repairing the vehicle pursuant to the repair order based upon the repair time, logistics, and repair costs.

12. The method of claim 6, further wherein said vehicle is located at a start location at the start of the period of use, and is returned to a return location at the end of the period of use, and further comprising the steps of:
providing a first plurality of cameras at an exit of the start location, said first plurality configured to record digital video information about the exterior condition of said vehicle as it leaves the start location; and
providing a second plurality of cameras at the entrance of the return location, said second plurality configured to record digital video information about the exterior condition of said vehicle as it arrives at the return location.

13. The method of claim 12, further comprising comparting the digital video information about the exterior condition of said vehicle as it arrives at the return location with the digital video information about the exterior condition of said vehicle as it leaves the start location to determine if the exterior of the vehicle has been damaged during the period of use.
